(19) United States
(12) Patent Application Publication
(10) Pub. No.: US 2002/0124459 A1
(43) Pub. Date: Sep. 12, 2002

(54) Stand for burnable coil

(76) Inventor: Brian T. Davis, Burlington, WI (US)

Correspondence Address: S.C. JOHNSON & SON, INC., 1525 HOWE STREET, RACINE, WI, 53403-2236, US

(21) Appl. No.: 09/803,321

(22) Filed: Mar. 9, 2001

(51) Int. Cl. A01M 13/00; A01M 19/00

(52) U.S. Cl. 43/125

(57) ABSTRACT

A stand supports a burnable coil such as a mosquito coil. There is a base suitable to rest on a support surface which is positionable at least partially beneath the coil. There is also a retainer clip linked to the base that is simultaneously positionable along a top side of the coil near a central opening of the coil, through the opening, and along a bottom side of the coil adjacent the opening. Methods of using such stands and stand/coil assemblies are described.

### CROSS-REFERENCE TO RELATED APPLICATIONS

Not applicable

### STATEMENT REGARDING FEDERALLY SPONSORED RESEARCH/DEVELOPMENT

Not applicable

### BACKGROUND OF THE INVENTION

The present invention relates to stands for supporting burnable coils while they are burning. It appears to be particularly well suited for use with mosquito coils that are thin.

Burnable coils, such as mosquito coils and incense coils, are designed to provide sustained vapor release. Because they burn slowly they are susceptible to being inadvertently extinguished, thereby rendering the coil ineffective. Inadvertent extinguishing can occur when too much heat is drawn from the coil by conduction to a contacting surface.

To minimize the likelihood of inadvertent extinguishing, such burnable coils are typically impaled on a spaded post which holds all but their center portion up away from contact with a supporting surface. Such spades are designed to make only minimal contact with the coil, and then only adjacent the last portion of the coil to be burnt.

However, some coils are made of a sufficiently flexible or fragile material that supporting them during burning merely from the center can lead to sagging of an outer portion of the coil, followed by inadvertent snuffing. Thus, the central spade is sometimes supplemented with additional raised points extending upward from a base bottom at other more radially remote positions under the coil. See e.g. U.S. Pat. Nos. 6,061,950 and 4,765,090. The disclosure of these patents and of all other publications referred to herein are incorporated by reference as if fully set forth herein.

While such supports are of assistance in reducing the incidence of snuffing, they require a more complex base which can be more expensive to manufacture. This can be of greatest concern in countries with exceptionally low annual incomes. Such countries are often significant markets for mosquito coils.

There have been attempts to design exceptionally thin mosquito coils that are mounted on a backing such as a round disk-shaped sheet of paper. Such coils have desirable burning characteristics. However, these coils have a tendency to sag if supported only from the center. Thus, a need exists for an inexpensive coil holder designed to better support this type of burnable coil.

### BRIEF SUMMARY OF THE INVENTION

In one aspect the invention provides a stand for supporting a burnable coil structure having an opening adjacent its center. The stand includes a base suitable to rest on a support surface. The base is positionable at least partially beneath the coil structure. There is also a retainer linked to the base that is simultaneously positionable along a top side of the coil structure near the opening of the coil structure, through the opening, and along a bottom side of the coil structure adjacent the opening. For purposes of this patent, the term “coil structure” shall be deemed to include both the coil itself and, where applicable, any backing that the coil may have.

The retainer is preferably U-shaped with two essentially horizontal arms (e.g. in the form of a clip having arms suitable to make simultaneous contact against the top side and the bottom side of the coil structure). In one set of embodiments, the base and retainer are formed from a continuous piece of wire. For example, the base can be a closed path extending from a catch end to an intermediate point engaged by the catch end. There can also be a riser section of the wire that extends from the base to the retainer.

The riser can either be positioned so as to pass outside and above the coil structure (so as to hang it from above), or be positioned directly under the coil structure so as to support the coil structure from underneath. This can advantageously be achieved by forming the retainer with a hairpin bend in it.

In another set of embodiments the retainer is formed from a single piece of sheet material (e.g. sheet metal). One form of this can have a planar base portion and a planar tab extending upwardly from that base portion, the tab having a lateral slot with an open end forming the retainer. If desired, the base can also have angled corners extending upwardly to support the outer periphery of the coil structure from below.

In another form the base and retainer are made of a sheet material, and the base includes a pair of planar feet joined to the retainer by an upwardly extending planar riser section. Alternatively, the sheet can form a convex surface to define the base which has extending therefrom a cut out tab to define the retainer.

In yet another embodiment, the base is an upright planar member having a segment from which the retainer extends along a plane of the planar member. Preferably, this base also includes at least two additional upright segments extending at an angle to the planar member, and both of the segments include an upper serrated edge.

In another form the invention provides an assembly for burning a fumigant. A burnable coil structure containing a fumigant is mounted on one of the supports described above with a first portion of the retainer being under a central portion of the coil structure, a second portion of the retainer passing through a central portion of the coil structure, and a third portion of the retainer passing over a central portion of the coil structure and also over at least part of the first portion of the retainer.

In still another form the invention provides a method for burning a fumigant. One obtains one of the assemblies described above, and then lights the coil structure adjacent a radially outward portion of the coil structure.

The preferred backing is a cellulosic (e.g. paper) backing layer in the form of a disk. However, the present invention also is well suited for use with even standard type coils. When the coil structure is used to control mosquitos, the coil portion is preferably a spiral substrate impregnated with an insecticide or insect repellant. We prefer a formulation of about 0.1% insecticide (e.g. esbiothrin or pynamin forte), 0.5%-5% charcoal, 1%-10% calcium carbonate, 0.1% dye and the remainder wood pulp. The coil can be made less than 2 mm thick and be supported on a thin continuous backing layer made from newsprint stock.

The stands of the present invention are preferably made of a steel wire or steel sheet metal, but could be made from other metal and non-metal materials as well. Given the environment in which these stands are to be used, it is important that the stands be fire resistant. Apart from this, materials can be selected to minimize cost. These stands use reduced amounts of materials, and are easy to form. They are light weight to ship, and some can even be stored and shipped in a flat state.

Thus, the present invention provides an inexpensive product to support a burnable coil structure while minimizing snuffing. The foregoing and other advantages of the invention will appear from the following description. In that description reference is made to the accompanying drawings which form a part hereof and in which there is shown by way of illustration preferred embodiments of the invention. These embodiments do not represent the full scope of the invention. Thus, the claims should be looked to in order to judge the full scope of the invention.

### BRIEF DESCRIPTION OF THE DRAWINGS

FIG. 1 is a top perspective view of a first stand of the present invention supporting a burnable coil structure;

FIG. 2 is a view similar to FIG. 1, but with the coil structure shown in phantom;

FIG. 3 is an enlarged side view, partially in section, taken along line 3-3 of FIG. 2, of a clip retainer portion of the assembly of FIG. 1;

FIG. 4 is a view similar to FIG. 2, but with a different stand being shown;

FIG. 5 is a view similar to FIG. 3, but taken along line 5-5 of FIG. 4;

FIG. 6 is a top perspective view of a third stand embodiment, again with the coil structure shown in phantom;

FIG. 7 is a view taken along line 7-7 of FIG. 6;

FIG. 8 is a top perspective view of a fourth stand embodiment, again with the coil structure shown in phantom;

FIG. 9 is a view similar to FIG. 3, but taken along line 9-9 of FIG. 8;

FIG. 10 is top perspective view of a fifth stand embodiment, again with the coil structure shown in phantom;

FIG. 11 is a view similar to FIG. 3, but taken along line 11-11 of FIG. 10;

FIG. 12 is a top perspective view of a sixth stand embodiment, again with a coil structure shown in phantom; and

FIG. 13 is a view similar to FIG. 3, but taken along line 13-13 of FIG. 12.

### DETAILED DESCRIPTION OF THE PREFERRED EMBODIMENTS

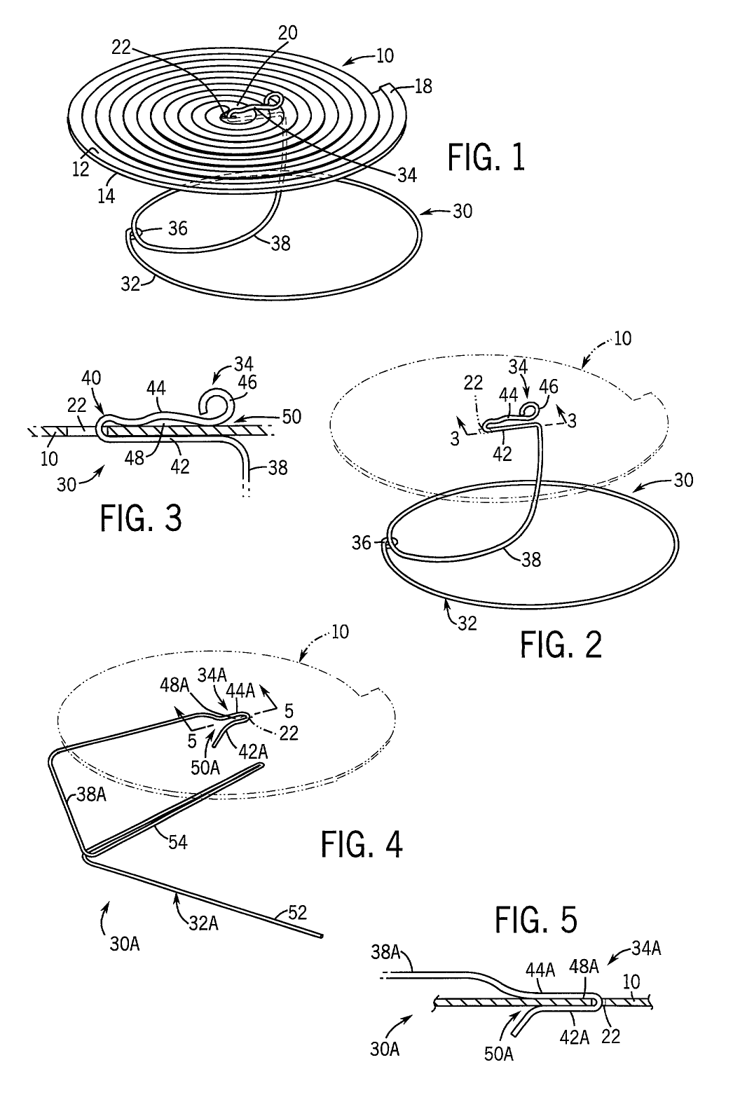

The stands of the present invention are particularly well suited for use with extremely thin burnable coils, such as the mosquito coil 10 shown in FIG. 1. These coils have desired burning characteristics (e.g., burn period, burn rate, etc.), and reduce the space taken up and weight of the product.

The coil is formed of a substrate 12 and is supported at its bottom side by a backing 14 of newsprint stock. While a continuous sheet of paper is preferred for this purpose, alternatively the paper could only extend directly under the coil.

As is conventional, the coil 10 has an outer burn end 18 which can be lit with a match or lighter until it begins a self-sustainable burning. The coil 10 spirals inwardly to an enlarged J-end 20 that is approximately in the center of the coil 10. If desired, the end could be made bulbous and a hole 22 of about 4-10 mm diameter could be formed directly through the bulbous end (as shown in FIG. 1). However, it is preferred that the hole instead be positioned between the legs of the end J through the paper.

For mosquito coils, the substrate 12 is preferably impregnated or coated with a suitable insecticide active ingredient or other types of active ingredients, such as known insecticides and insect repellants, that release when the coil is burned (e.g. esbiothrin, pynamin forte, transfluthrin). Alternatively, the coil substrate could be treated with other heat-releasable active ingredients, such as fingicides or deodorizers, fragrances and the like, for use as an aroma dispenser.

The figures show various preferred embodiments of a stand designed to support the above described coils during burning. While the various disclosed embodiments have differing structures, they all include a retainer feature designed to make line contact (at least) with a center bottom portion of the coil structure.

Referring specifically to FIGS. 1-3, a first preferred coil stand 30 is made from a steel wire forming a base 32 and a clip 34. The wire has a looped catch end 36 through which an intermediate point of the wire is disposed to form a generally circular ring defining the base 32. A riser portion 38 extends inward and upward to a clip end 40 approximately above the center of the base 32.

The clip end 40 is bent in hairpin fashion to form two extension arms 42 and 44, with the bottom extension arm 42 being generally parallel to the base 32. The upper extension arm 44 can be formed with undulations and a curled back tip 46 (as best shown in FIG. 3). The clip extension arms 42 and 44 define a narrow slot 48 there between with an open mouth 50 at one end.

The coil structure 10 is clipped to the stand 30 by inserting the curved back tip 46 through the opening 22 in the coil structure 10 and sliding a part of the central portion of the coil structure 10 into the slot 48. In this way, the bottom clip extension arm 42 supports the bottom side of the coil structure 10 in line contact along the length of the bottom clip extension arm 42. However, because there is a layer of paper between the wire and the coil structure 10, and because the wire extends only a short distance in one direction, the snuffing potential is low due to this feature.

The upper clip extension arm 44 can similarly make line contact with the top side of the coil structure 10 along the low sections of the undulations. The short distance of the top arm 44, and the undulations, help reduce snuffing potential due to that feature.

Thus, the coil structure 10 is securely clipped to the stand 30 at the top and bottom along the short width of the clip 34. While this provides sufficient support to prevent the coil structure 10 from sagging too far, it only contacts the center of the coil structure 10, and in line contact at that, so as not to snuff the coil structure 10 when burning.

An alternative stand embodiment 30A is shown in FIGS. 4 and 5. Elements similar to the above described embodiment are referred to similarly, albeit with the suffix A. Stand 30A is a wire “gallows” type frame formed of a base 32A, a clip 34A and a riser portion 38A. Base 32A has a pair of generally co-planar legs 52 and 54, preferably with only an acute angle there between.

The wire is bent so that leg 54 comprises two oppositely extending runs of wire. The riser 38A extends upwardly from the intersection of the legs 52 and 54. The riser 38A begins extending radially outwardly from the legs 52 and 54, then bends inwardly and upwardly (then slightly downwardly)to the clip 34A, which is above the base 32A and between the legs 52 and 54.

Referring to FIG. 4, it can be seen that the clip 34A has two generally parallel clip extensions 42A and 44A defining a slot 48A there between with an open mouth 50A. The end of clip extension 42A is preferably bent downwardly away from clip extension 44A.

Coil structure 10 is clipped to the stand 30A through the center opening 22. However, here the riser 38A runs to the clip 32A from above the coil structure 10 so as to “hang” the coil structure 10 from above, rather than support it from below. Specifically, the bent end of clip extension 44A is inserted into the opening 22 in the coil structure 10 from above and a portion of the coil structure 10 is pulled into the slot 48A until it contacts the closed end of the clip 34A. In this position, the coil structure 10 is securely suspended due to the line contact between the clip extensions 42A and 44A and the respective bottom and top of the coil structure 10.

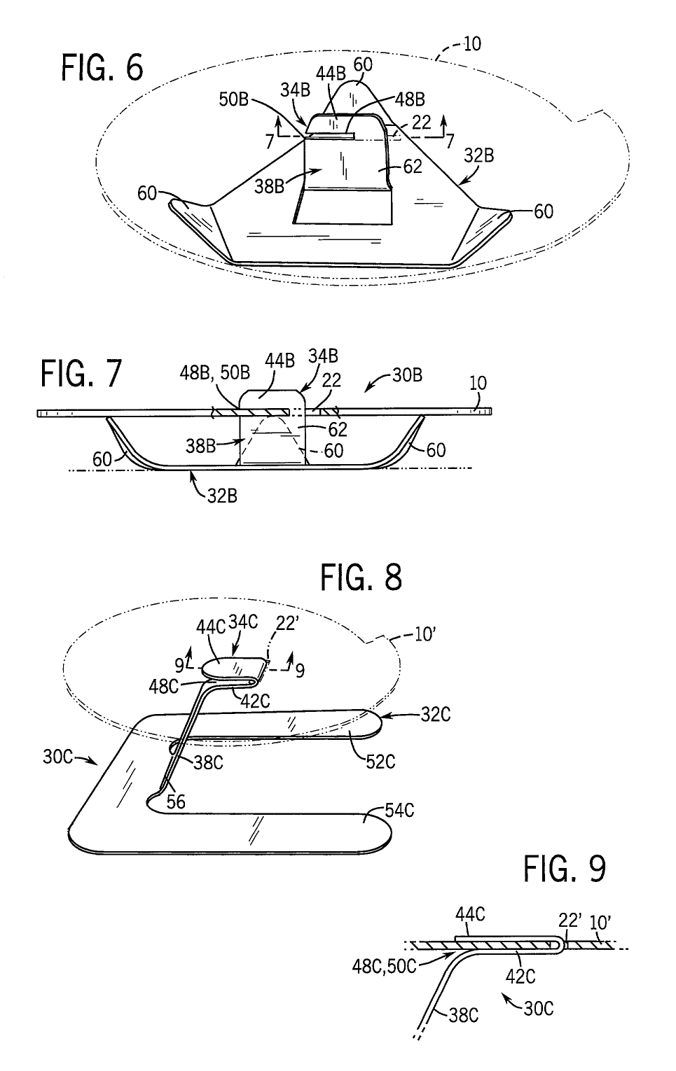

A third stand embodiment 30B is depicted in FIGS. 6 and 7. Elements similar to the above described embodiments are referred to similarly albeit with the suffix B. Unlike the above embodiments, stand 30B is made of a suitable sheet material (e.g. sheet metal), rather than wire. The stand 30B is preferably generally a triangular section with upwardly angled corners 60 being part of base 32B.

A tab 62 is cut out along three sides from the center of the base 32B and is bent upwardly. The tab 62 forms a riser 38B with a clip 34B having a clip extension 44B defining a lateral slot 48B having a open mouth 50B. Preferably, the bottom of the slot 48B is in generally the same lateral plane as the tips of the bent up corners 60.

Referring more particularly to FIG. 7, the coil structure 10 is clipped to the stand 30B by inserting the clip extension 44B into the center opening 22 of the coil structure 10 and sliding the coil structure 10 to the end of the slot 48B. Here again, the coil structure 10 is supported in line contact at the top and bottom sides. Additionally, the bent up corners 60 can support the coil structure 10 from below at three remote locations radially outward from the center if the coil structure should sag slightly. The corners 60 make as little point contact as possible.

A fourth stand embodiment 30C is shown in FIGS. 8 and 9. Elements similar to the above described embodiments are referred to similarly albeit with the suffix C. Stand 30C is also made from a metal sheet material forming an E-shaped structure laid flat, albeit with the middle leg bend upward. In particular, the sheet material forms a base 32C having generally coplanar parallel legs 52C and 54C extending laterally and connected at one end by a section of sheet material from which a middle leg 56 (forming the riser 38C) extends upwardly to a clip 34C. The clip 34C is a bent back section forming two lateral extensions 42C and 44C defining a slot 48C there between with an open mouth 50C at one end.

Referring to FIG. 9, a coil structure 10′, having a larger opening 22′ than coil structure 10, is clipped to the stand 30C by inserting clip extension 44C into the opening 22′ and sliding the coil structure 10′ to the end of the slot 48C. As before, the coil structure 10′ is supported at its top and bottom sides. However, here the clip 34C makes surface contact with a small portion of the center of the coil structure 10′.

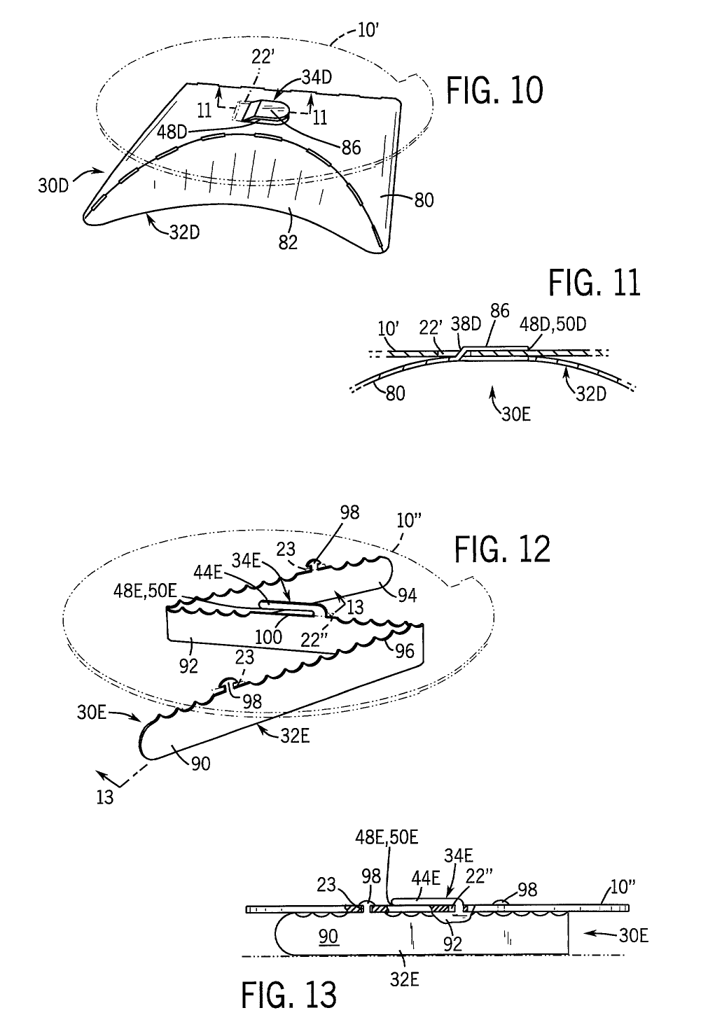

A fifth stand embodiment 30D is shown in FIGS. 10 and 11. Elements similar to the above described embodiments are referred to similarly albeit with the suffix D. Stand 30D is made from a sheet material forming a base 32D having an convex upper surface 80 and two arcuate upright sides 82 (one shown). A tab 86 is notched out of the center of the convex upper surface 80 and is bent upward slightly to define a riser 38D and a clip 34D. The tab 86 includes a lateral slot 48D having an open mouth 50D.

Referring to FIG. 11, the coil structure 10′ is clipped to the stand 30D by inserting the tab 86 into the opening 22′ and sliding the coil structure 10′ to the end of the slot 48D. Here, the clip 34D (at the underside of the tab 86) makes surface contact with a top portion of the coil structure 10′ and the base 32D (at the convex surface 80) makes surface contact with a bottom portion of the coil structure 10′.

A sixth stand embodiment 30E is shown in FIGS. 12 and 13. Elements similar to the above described embodiments are referred to similarly albeit with the suffix E. Stand 30E is formed of an elongated section of metal sheet material folded into three convoluted upright segments 90, 92 and 94, forming a base 32E. The segments 90, 92 and 94 have a serrated upper edge 96. Also, segments 90 and 94 each have a projection 98 extending upwardly from the serrated upper edge 96. In the middle of segment 92 is a flat (non-serrated) upper edge 100 where a clip extension 44E runs parallel thereto to define a slot 48E there between having an open mouth 50E at one end, thus forming a clip 34E.

Referring to FIG. 13, a coil structure 10″, having a small opening 22″ (as in coil structure 10) and a pair of small remote openings 23, is clipped to the stand 30E by inserting the clip extension 44E through the opening 22″ in the coil structure 10″ and sliding the coil structure 10″ to the end of the slot 48E. The coil structure 10″ can be rotated, if needed, to align the remote openings 23 with the base projections 98 so that they can be inserted therein. The stand 30E thus supports the coil structure 10″ at the center as well as at remote locations radially outward from the center. As before, the clip 34E makes line contact with center portions of the top and bottom sides of the coil structure 10″.

Thus, the present invention provides a stand particularly well suited for supporting large-diameter, low-profile burnable coils. The stand can take various forms, all of which can be formed from inexpensive materials and include a retainer feature that makes line or surface contact with a portion of the coil center to support it securely in the air during use without snuffing the burning coil.

While specific embodiments have been shown, various modifications falling within the breadth and scope of the invention will be apparent to one skilled in the art. Thus, the following claims should be looked to in order to understand the full scope of the invention.

I claim:

1. A stand for supporting a burnable coil structure, the burnable coil structure being of the type having an opening adjacent its center, the stand comprising:
a base suitable to rest on a support surface and being positionable at least partially beneath the coil structure; and
a retainer linked to the base that is simultaneously positionable along a top side of the coil structure near the opening of the coil structure, through the opening, and along a bottom side of the coil structure adjacent the opening.

2. The stand of claim 1, wherein the retainer is in the form of a U-shaped retainer that has two essentially horizontal arms.

3. The stand of claim 2, wherein the U-shaped retainer is a hairpin shaped clip having arms suitable to make simultaneous contact against the top side and the bottom side of the coil structure if the coil structure is mounted on the stand.

4. The stand of claim 1, wherein the base and retainer are formed from a single continuous piece of wire.

5. The stand of claim 4, wherein the base is a closed path extending from a catch end to an intermediate point engaged by the catch end.

6. The stand of claim 4, wherein a riser section of the wire extends from the base to the retainer.

7. The stand of claim 6, wherein the riser is positionable so as to be suitable to pass outside and above the coil structure, so as to be suitable to hang the coil structure from above if the coil structure is mounted on the stand.

8. The stand of claim 6, wherein the riser is positionable so as to support the coil structure from underneath the coil structure.

9. The stand of claim 1, wherein the base and retainer are formed from a single piece of sheet material.

10. The stand of claim 9, having a planar base portion and a planar tab extending upwardly from that base portion, the tab having a lateral slot with an open end defining the retainer.

11. The stand of claim 10, wherein the base has angled corners extending upwardly.

12. The stand of claim 9, wherein the base includes a pair of planar feet joined to the retainer by an upwardly extending planar riser section.

13. The stand of claim 9, wherein the sheet forms a convex surface forming the base and has extending therefrom is a cut out tab that is part of the retainer.

14. The stand of claim 9, wherein the base is an upright planar member having a segment from which the retainer extends along a plane of the planar member.

15. The stand of claim 14, wherein the base also includes at least two additional upright segments extending at an angle to the planar member.

16. The stand of claim 15, wherein both of the segments includes an upper serrated edge.

17. An assembly for burning a fumigant, comprising:
a burnable coil structure containing a fumigant mounted on a support of claim 1 such that simultaneously a first portion of the retainer is under a central portion of the coil structure, a second portion of the retainer extends through a central portion of the coil structure, and a third portion of the retainer extends over a central portion of the coil structure and also over at least part of the first portion of the retainer.

18. A method for burning a fumigant, comprising:
lighting a radially outward portion of the coil structure of claim 17.
